(19) United States
(12) Patent Application Publication
(10) Pub. No.: US 2013/0054878 A1
(43) Pub. Date: Feb. 28, 2013

(54) SOLID STATE DRIVE AND WEAR-LEVELING CONTROL METHOD THEREOF

(71) Applicants: Shih-Chiang Lee, Hsinchu (TW); Ling-Feng Chen, Hsinchu (TW)

(72) Inventors: Shih-Chiang Lee, Hsinchu (TW); Ling-Feng Chen, Hsinchu (TW)

(73) Assignee: LITE-ON IT CORPORATION, Taipei (TW)

(21) Appl. No.: 13/413,732

(22) Filed: Mar. 7, 2012

(30) Foreign Application Priority Data
Aug. 25, 2011 (CN) 201110244764.1

(51) Int. Cl. G06F 12/00

(52) U.S. Cl. 711/103; 711/E12.008

(57) ABSTRACT

A flash memory includes a first block with a first erase count and a second block with a second erase count. A first data corresponding to a first history index number is stored in the first block. A second data corresponding to a second history index number is stored in the second block. A controlling unit is connected with the flash memory, and includes a history index number generator for generating a plurality of history index numbers, which at least comprise the first history index number and the second history index number. According to the first erase count, the first history index number, the second erase count and the second history index number, the controlling unit determines whether a data swapping operation for exchanging the first data and the second data has to be performed or not.

This application claims the benefit of People's Republic of China Application Serial No. 201110244764.1, filed Aug. 25, 2011, the subject matter of which is incorporated herein by reference.

### FIELD OF THE INVENTION

The present invention relates to a solid state drive and a control method thereof, and more particularly to a solid state drive and a wear-leveling control method thereof.

### BACKGROUND OF THE INVENTION

As is well known, a solid state drive (SSD) is a data storage device that uses a NAND-based flash memory to store data. The NAND-based flash memory is a non-volatile memory. After data are written to the flash memory, if no power is supplied to the flash memory, the data are still retained in the flash memory.

FIG. 1 is a schematic functional block diagram illustrating a conventional solid state drive. As shown in FIG. 1, the solid state drive 10 comprises a controlling unit 101 and a flash memory 105. The flash memory 105 is accessible by the controlling unit 101 through an internal bus 107. In addition, the controlling unit 101 is in communication with a host 12 through an external bus 20. Consequently, commands and data can be exchanged between the controlling unit 101 and the host 12. Generally, the external bus 20 is a USB bus, an IEEE 1394 bus, an SATA bus, or the like.

Generally, the flash memory 105 comprises a plurality of blocks. Each block comprises a plurality of pages (or sectors), for example 64 pages. Each page is typically 4K bytes in size. Due to the inherent properties of the flash memory 105, at least one page is written at a time during the writing operation, and the erasing operation is performed in a block-wise fashion.

Generally, each block of the flash memory 105 has limited erase count. For prolonging the life of the flash memory 105, a wear leveling technique is disclosed. According to the wear leveling technique, the writing operations on all available blocks of the flash memory 105 are balanced in order to prevent overuse of specified blocks (high erase counts) and occurrence of bad blocks. In such way, the life of the flash memory 105 will be prolonged.

Generally, if the block is frequently erased, it means that the data in the block is frequently refreshed and may be considered as a hot data. Whereas, if the block is seldom erased, it means that the data in the block is seldom refreshed and may be considered as a cold data.

The erase counts of all blocks of the flash memory 105 are usually recorded in the conventional solid state drive 10. For performing the wear leveling operation, the conventional solid state drive 10 may judge whether the data in the blocks are hot data or cold data according to the erase counts of respective blocks. Generally, the erase count is the only index for allowing the conventional solid state drive 10 to judge whether the data in the blocks are hot data or cold data.

For performing the wear leveling operation, the controlling unit 101 of the conventional solid state drive 10 is used to detect the erase count of each block of the flash memory 105 and perform a data swapping operation to exchange data between the high erase-count block and the low erase-count block. That is, after the data swapping operation is performed, the hot data in the high erase-count block is transferred and stored into the low erase-count block, and the cold data in the low erase-count block is transferred and stored into the high erase-count block.

FIG. 2 is a flowchart illustrating a conventional wear leveling method. Firstly, a first block with a high erase count is searched from the flash memory, wherein a first data is stored in the first block (Step S310). Then, a second block with a low erase count is searched from the flash memory, wherein a second data is stored in the second block (Step S320). Then, a data swapping operation is performed, so that the first data in the first block and the second data in the second block are exchanged (Step S330).

From the above discussions, the conventional wear leveling method determines the blocks whose data need to be exchanged according to erase counts of all blocks. Then, the data swapping operation is performed to transfer and store the cold data into the high erase-count block. In such way, the frequency of erasing such a block will be reduced.

FIGS. 3A˜3G schematically illustrate a data-exchanging process of the conventional wear leveling method. As shown in FIG. 3A, the flash memory 105 comprises three blocks. The first block (Block1) has an erase count hi, which is denoted as Block1_{—}hi. The second block (Block2) has an erase count lo, which is denoted as Block2_{—}lo. The third block (Block3) is a blank block and has an erase count n, which is denoted as Block3_{—}n. The relationship between the three erase counts may be indicated as: hi>n>lo.

By comparing the erase counts of these three blocks, the controlling unit 101 will judge that the data in the first block is a hot data (Data_hot) and the data in the second block is a cold data (Data_cold). During the wear leveling method is performed, the controlling unit 101 will control the data exchange between the first block and the second block.

For rendering the data exchange between the first block and the second block, the following steps as shown in FIGS. 3B˜3G are sequentially done. As shown in FIG. 3B, the data in the second block (i.e. Data_cold) is copied to the third block. Then, as shown in FIG. 3C, the data in the second block is erased, so that the second block becomes a blank block. Meanwhile, the erase count of the second block is added by 1 and denoted as Block2_(lo+1).

Then, as shown in FIG. 3D, the data in the first block (i.e. Data_hot) is copied to the second block. Then, as shown in FIG. 3E, the data in the first block is erased, so that the first block becomes a blank block. Meanwhile, the erase count of the first block is added by 1 and denoted as Block1_(hi+1).

Then, as shown in FIG. 3F, the data in the third block (i.e. Data_cold) is copied to the first block. Then, as shown in FIG. 3G, the data in the third block is erased, so that the third block becomes a blank block. Meanwhile, the erase count of the third block is added by 1 and denoted as Block3_(n+1).

From the above description, the wear leveling method is performed by firstly determining two blocks whose data are intended to be exchanged according to the erase counts. The data in the high erase-count block is considered as the hot data, and the data in the low erase-count block is considered as the cold data. When the data swapping operation is performed, the hot data is transferred and stored into the low erase-count block, and the cold data is transferred and stored into the high erase-count block.

However, the use of the erase count to search the block in the conventional wear leveling method may result in some drawbacks.

For example, if the solid state drive 10 has never implemented the wear leveling method, the data in the low erase-count block is the cold data, and the data in the high erase-count block is the hot data. After the wear leveling method is performed, as shown in FIG. 3G, the data in the high erase-count block is replaced with the cold data, and the data in the low erase-count block is replaced with the hot data.

Under this circumstance, if the wear leveling method is implemented again, the first block with the high erase count may be considered as the hot data by the controlling unit 101 because the block is searched by the controlling unit 101 according to the erase count. In such way, the data in the first block (i.e. Data_cold) and the data in the second block (i.e. Data_hot) as shown in FIG. 3G are exchanged and returned to the original state as shown in FIG. 3A. Since the hot data is stored back to the block with the high erase count and the cold data is stored back to the block with the low erase count after the wear leveling method is implemented, the wear leveling efficacy is unsatisfied.

As known, the life of the solid state drive is highly related to the performance of the wear leveling method. If the block is searched according to the erase count only, the wear leveling efficacy is impaired and even the life of the solid state drive is shortened.

Therefore, there is a need of providing a solid state drive with enhanced wear leveling efficacy, thereby increasing the life thereof.

### SUMMARY OF THE INVENTION

A first embodiment of the present invention provides a solid state drive. The solid state drive includes a flash memory and a controlling unit. The flash memory includes a plurality of blocks, which at least include a first block with a first erase count and a second block with a second erase count. A first data corresponding to a first history index number is stored in the first block. A second data corresponding to a second history index number is stored in the second block. The controlling unit is connected with the flash memory, and includes a history index number generator for generating a plurality of history index numbers, which at least comprise the first history index number and the second history index number. According to the first erase count, the first history index number, the second erase count and the second history index number, the controlling unit determines whether a data swapping operation for exchanging the first data and the second data has to be performed or not.

A second embodiment of the present invention provides a wear-leveling control method for a solid state drive. The wear-leveling control method includes the following steps. Firstly, a first block with a first erase count is searched from a flash memory, wherein a first data corresponding to a first history index number is stored in the first block. Then, a second block with a second erase count is searched from the flash memory, wherein a second data corresponding to a second history index number is stored in the second block, wherein the first erase count is greater than the second erase count. Then, a judging step is performed to judge whether the first history index number is greater than the second history index number or not. If the first history index number is greater than the second history index number, a data swapping operation is performed, so that the first data in the first block and the second data in the second block are exchanged. Whereas, if the first history index number is not greater than the second history index number, the data swapping operation is not done.

A third embodiment of the present invention provides a wear-leveling control method for a solid state drive. The wear-leveling control method includes the following steps. Firstly, a first block with a first erase count is searched from a flash memory, wherein a first data corresponding to a first history index number is stored in the first block. Then, a second block with a second erase count is searched from the flash memory, wherein a second data corresponding to a second history index number is stored in the second block. If the first erase count is greater than the second erase count and the first history index number is greater than the second history index number, a data swapping operation is performed, so that the first data in the first block and the second data in the second block are exchanged.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior art) is a schematic functional block diagram illustrating a conventional solid state drive;

FIG. 2 (Prior art) is a flowchart illustrating a conventional wear leveling method;

FIGS. 3A˜3G (Prior art) schematically illustrate a data-exchanging process of the conventional wear leveling method;

FIG. 4 is a schematic functional block diagram illustrating a solid state drive according to an embodiment of the present invention;

FIG. 5 is a flowchart illustrating a wear-leveling control method according to an embodiment of the present invention; and

FIG. 6 is a flowchart illustrating a wear-leveling control method according to another embodiment of the present invention.

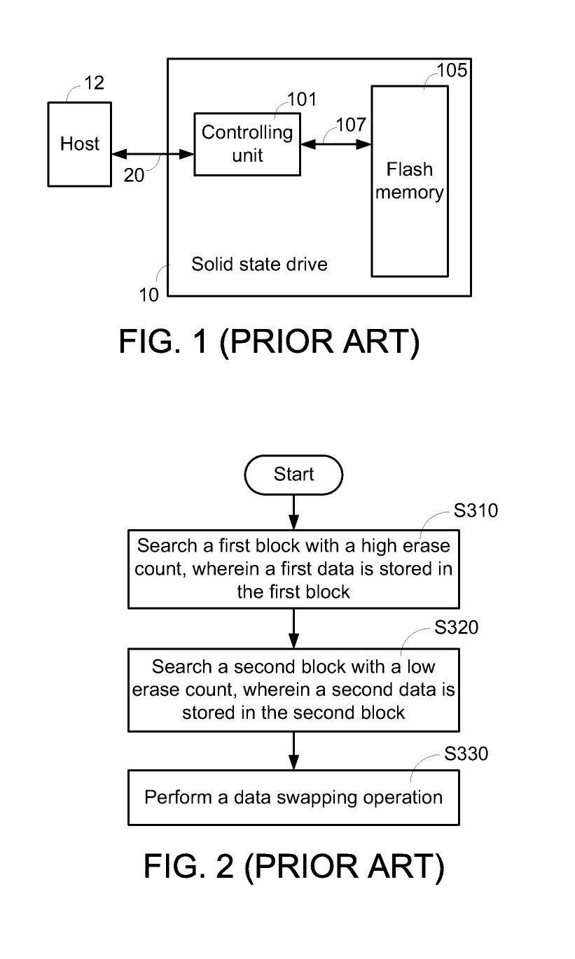

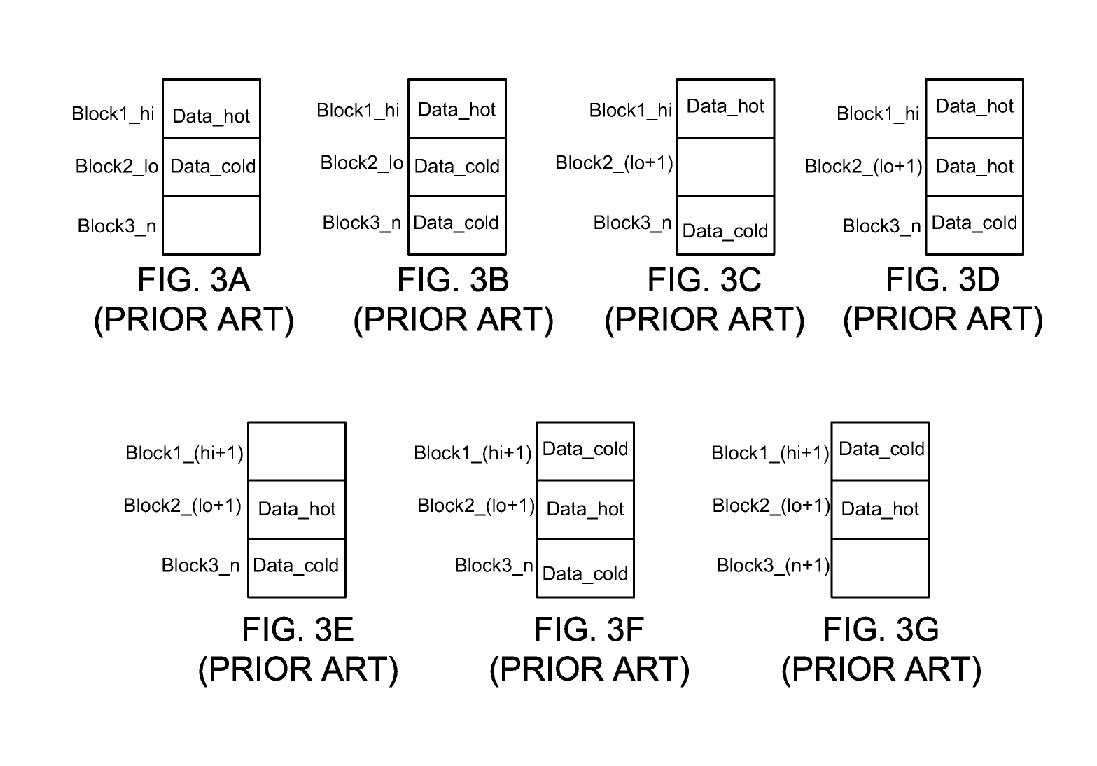

### DETAILED DESCRIPTION OF PREFERRED EMBODIMENTS

The present invention provides a solid state drive and a wear-leveling control method thereof. In addition to the erase count of each block, a corresponding history index number is recorded in the solid state drive. In other words, both the erase count of each block and the corresponding history index number are recorded in the solid state drive.

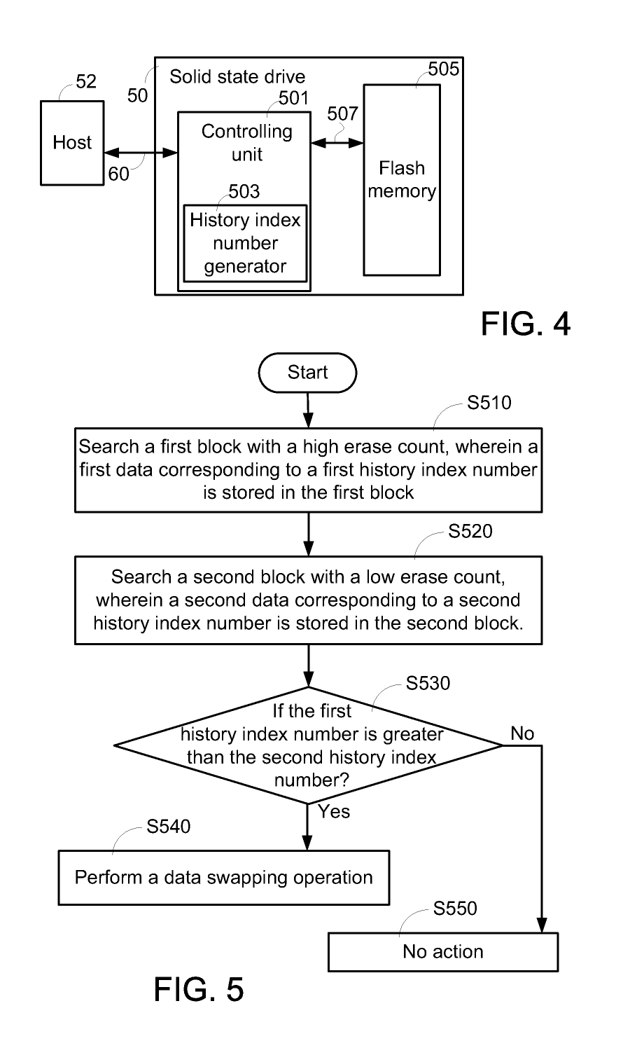

FIG. 4 is a schematic functional block diagram illustrating a solid state drive according to an embodiment of the present invention.

As shown in FIG. 4, the solid state drive 50 comprises a controlling unit 501 and a flash memory 505. The flash memory 505 is accessible by the controlling unit 501 through an internal bus 507. In addition, the controlling unit 501 is in communication with a host 52 through an external bus 60. Consequently, commands and data can be exchanged between the controlling unit 501 and the host 52. Generally, the external bus 60 is a USB bus, an IEEE 1394 bus, an SATA bus, or the like.

The controlling unit 501 further comprises a history index number generator 503. When a write data generated by the host 52 is stored into a specified block, a history index number corresponding to the write data is generated by the history index number generator 503. And, the corresponding history index number is stored with the write data into the specific block. In other words, the history index number increases as time increases. According to the history index numbers of the data of all blocks, the controlling unit 501 can realize the sequence of writing the data into all blocks. Hereinafter, some kinds of history index number will be illustrated in more details.

A first kind of history index number increases as the number of times the write data generated by the host is written into the blocks increases. That is, the history index numbers generated by the history index number generator are positively correlated with the number of times the write data are written into the plurality of blocks. After the solid state drive 50 leaves the factory, the history index number generator 503 will continuously generate the history index numbers in an ascending order according to the number of times the host writes data to the block increases. For example, when the solid state drive 50 leaves the factory, a first data generated by the host is written into the first block. Consequently, the first history index number is 1, which is stored into the first block with the first data. Similarly, when a fifth data is written into the fifth block, the history index number corresponding to the fifth data is 5, which is stored into the fifth block with the fifth data.

Then, if the first block is erased, the first data is deleted, and the history index number “1” stored is also deleted. Once a sixth data generated by the host is written into the first block again, the history index number corresponding to the sixth data is 6. That is, the sixth data with the history index number “6” is stored into the first block.

Moreover, if the data exchange between the fifth block and the first block is performed, the sixth data with the history index number “6” is stored into the fifth block, and the fifth data with the history index number “5” is stored into the first block.

A second kind of history index number increases as the time increases. After the solid state drive 50 leaves the factory, if the solid state drive 50 is powered on, the history index number generator 503 will periodically add 1 to the history index number in every predetermined time interval. When a data generated by the host is written into a specified block, a corresponding history index number generated by the history index number generator 503 at the corresponding time spot is also recorded into the specified block.

For example, when the solid state drive 50 leaves the factory, a first data generated by the host is written into the first block at a specified time spot. If the history index number generated by the history index number generator 503 at this specified time spot is T1, the history index number corresponding to the first data in the first block is T1, which is stored into the first block with the first data. Then, when a fifth generated by the host is written into the fifth block at another specified time spot and a history index number “T5” is generated by the history index number generator 503, the history index number corresponding to the fifth data in the fifth block is T5, which is stored into the fifth block with the fifth data. Obviously, the history index number “T5” is greater than the history index number “T1”.

Then, if the first block is erased, the first data is deleted, and the history index number “T1” stored is also deleted. Once a sixth data generated by the host is written into the first block again and a history index number “T6” is generated by the history index number generator 503, the history index number corresponding to the sixth data in the first block is T6, which is stored into the first block with the sixth data. Obviously, the history index number “T6” is greater than the history index number “T5”.

Moreover, if the data exchange between the fifth block and the first block is performed, the sixth data with the history index number “T6” is stored into the fifth block, and the fifth data with the history index number “T5” is stored into the first block.

From the above discussion, it is found that the history index numbers are equivalent to the sequence of writing the data. That is, the controlling unit 501 may realize the length of the time period after the data has been stored into the specified block of the flash memory 505 according to the corresponding history index number. For example, the data with the larger history index number has been stored into the flash memory 505 for a shorter time period. That is, the data with the larger history index number has been recently refreshed and may be considered as a hot data. Whereas, the data with the smaller history index number has been stored into the flash memory 505 for a longer time period. That is, the data with the smaller history index number has not been refreshed for a long time period and may be considered as a cold data.

In accordance with a key feature of the present invention, the wear leveling operation is performed by referring to the erase count of each block and the history index number corresponding to the data stored into the block.

FIG. 5 is a flowchart illustrating a wear-leveling control method according to an embodiment of the present invention. Firstly, a first block with a high erase count is searched from the flash memory 505 by the controlling unit 501, wherein a first data corresponding to a first history index number is stored in the first block (Step S510). Then, a second block with a low erase count is searched from the flash memory 505 the controlling unit 501, wherein a second data corresponding to a second history index number is stored in the second block (Step S520). Then, a step S530 is performed to judge whether the first history index number is greater than the second history index number.

If the first history index number is greater than the second history index number, a data swapping operation is performed, so that the first data in the first block and the second data in the second block are exchanged (Step S540). Whereas, if the first history index number is smaller than the second history index number, the data swapping operation is not done (Step S550).

As shown in FIG. 5, if the first history index number is smaller than the second history index number, it means that the first data in the first block has been stored into the flash memory 505 for a longer time period. That is, the first data has not been refreshed for a long time period and may be considered as a cold data. Whereas, since the second data in the second block has been stored in the flash memory 505 for a shorter time period, the second data has been recently refreshed and may be considered as a hot data. Meanwhile, although the erase count of the first block is higher, since the first data stored in the first block is the cold data, it is not necessary to perform the data swapping operation.

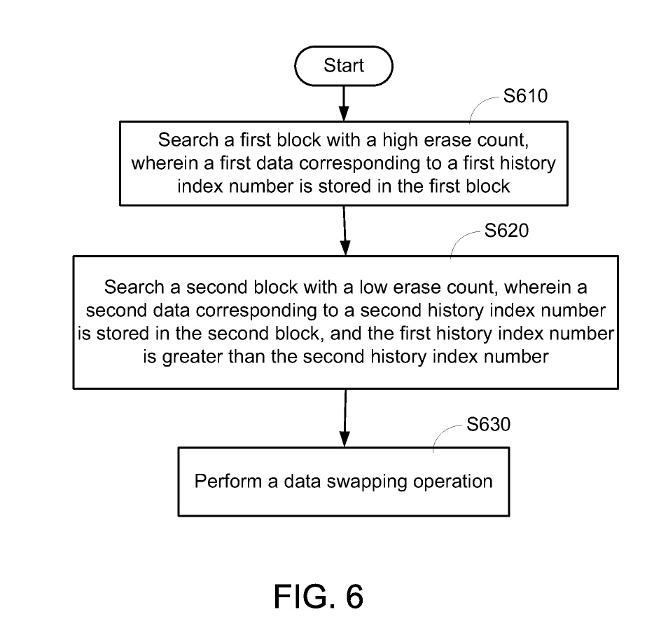

FIG. 6 is a flowchart illustrating a wear-leveling control method according to another embodiment of the present invention. Firstly, a first block of the flash memory 505 with a high erase count is determined by the controlling unit 501, wherein a first data corresponding to a first history index number is stored in the first block (Step S610). Then, a second block of the flash memory 505 with a low erase count is determined by the controlling unit 501, wherein a second data corresponding to a second history index number is stored in the second block and the first history index number is higher than the second history index number (Step S620). Then, a data swapping operation is performed, so that the first data in the first block and the second data in the second block are exchanged (Step S630).

From the above discussions in FIG. 6, after the controlling unit 501 realizes that the second data corresponding to a lower history index number (i.e. the second history index number) is stored in the second block with a lower erase count, the controlling unit 501 will compare the first block with the second block. Consequently, the first data in the first block is considered as the hot data, and the second data in the second block is considered as the cold data. Under this circumstance, the data swapping operation is necessary to transfer the first data (i.e. the hot data) to the second block with the lower erase count.

From the above description, the wear-leveling control method of the present invention implement the wear leveling operation by referring to the erase count of each block and the history index number corresponding to the data stored in the block. In such way, the wear-leveling efficacy is enhanced, and thus the life of the solid state drive is extended.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A solid state drive, comprising:
a flash memory comprising a plurality of blocks, which at least comprise a first block with a first erase count and a second block with a second erase count, wherein a first data corresponding to a first history index number is stored in the first block, and a second data corresponding to a second history index number is stored in the second block; and
a controlling unit connected with the flash memory, and comprising a history index number generator for generating a plurality of history index numbers, which at least comprise the first history index number and the second history index number,
wherein the controlling unit determines whether a data swapping operation for exchanging the first data and the second data has to be performed or not according to the first erase count, the first history index number, the second erase count and the second history index number.

2. The solid state drive as claimed in claim 1, wherein if the first erase count is greater than the second erase count and the first history index number is greater than the second history index number, the data swapping operation is performed.

3. The solid state drive as claimed in claim 1, wherein the plurality of history index numbers generated by the history index number generator are positively correlated with the number of times a plurality of write data are written into the plurality of blocks, wherein the plurality of write data at least comprise the first data and the second data.

4. The solid state drive as claimed in claim 1, wherein the plurality of history index numbers are periodically generated in every predetermined time interval and in an ascending order by the history index number generator.

5. A wear-leveling control method for a solid state drive, the wear-leveling control method comprising steps of:
searching a first block with a first erase count from a flash memory, wherein a first data corresponding to a first history index number is stored in the first block;
searching a second block with a second erase count from the flash memory, wherein a second data corresponding to a second history index number is stored in the second block, wherein the first erase count is greater than the second erase count; and
judging whether the first history index number is greater than the second history index number or not, wherein if the first history index number is greater than the second history index number, a data swapping operation is performed, so that the first data in the first block and the second data in the second block are exchanged, wherein if the first history index number is not greater than the second history index number, the data swapping operation is not done.

6. The wear-leveling control method as claimed in claim 5, wherein the solid state drive has a history index number generator for sequentially generating a plurality of history index numbers, which at least comprise the first history index number and the second history index number.

7. The wear-leveling control method as claimed in claim 6, wherein the plurality of history index numbers are positively correlated with the number of times a plurality of write data are written into a plurality of blocks, wherein the plurality of write data at least comprise the first data and the second data, and the plurality of blocks at least comprise the first block and the second block.

8. The wear-leveling control method as claimed in claim 6, wherein the plurality of history index numbers are periodically generated in every predetermined time interval and in an ascending order.

9. A wear-leveling control method for a solid state drive, the wear-leveling control method comprising steps of:
searching a first block with a first erase count from a flash memory, wherein a first data corresponding to a first history index number is stored in the first block;
searching a second block with a second erase count from the flash memory, wherein a second data corresponding to a second history index number is stored in the second block; and
if the first erase count is greater than the second erase count and the first history index number is greater than the second history index number, performing a data swapping operation, so that the first data in the first block and the second data in the second block are exchanged.

10. The wear-leveling control method as claimed in claim 9, wherein the solid state drive has a history index number generator for sequentially generating a plurality of history index numbers, which at least comprise the first history index number and the second history index number.

11. The wear-leveling control method as claimed in claim 10, wherein the plurality of history index numbers are positively correlated with the number of times a plurality of write data are written into the plurality of blocks, wherein the plurality of write data at least comprise the first data and the second data.

12. The wear-leveling control method as claimed in claim 10, wherein the plurality of history index numbers are periodically generated in every predetermined time interval and in an ascending order.
